(19) United States
(12) Patent Application Publication
(10) Pub. No.: US 2023/0177387 A1
(43) Pub. Date: Jun. 8, 2023

(54) METALEARNER FOR UNSUPERVISED AUTOMATED MACHINE LEARNING

(71) Applicant: INTERNATIONAL BUSINESS MACHINES CORPORATION, ARMONK, NY (US)

(72) Inventors: Saket Sathe, Mohegan Lake, NY (US); Long Vu, Chappaqua, NY (US); Peter Daniel Kirchner, Putnam Valley, NY (US); Charu C. Aggarwal, Yorktown Heights, NY (US)

(21) Appl. No.: 17/643,242

(22) Filed: Dec. 8, 2021

(51) Int. Cl. G06N 20/00

(52) U.S. Cl. CPC G06N 20/00

(57) ABSTRACT

A method, system, and computer program product for a metalearner for automated machine learning are provided. The method receives a labeled data set. A set of data subsets is generated from the labeled data set. A set of unsupervised machine learning pipelines is generated. A training set is generated from the set of data subsets and the set of unsupervised machine learning pipelines. The method trains a metalearner for unsupervised tasks based on the training set.

### BACKGROUND

Machine learning systems and methods have proliferated in recent years. Supervised machine learning uses labeled data sets to train machine learning algorithms. Unsupervised machine learning uses unlabeled data sets to train machine learning algorithms. Supervised machine learning algorithms and unsupervised machine learning algorithms are often tested by predict labels on unlabeled test data sets for which suitable labels are known but not provided to the machine learning algorithm under test. Automated machine learning (AutoML) systems automate tasks of generating and testing machine learning algorithms to apply machine learning to real world problems with fewer user interactions.

### SUMMARY

According to an embodiment described herein, a computer-implemented method for a metalearner for automated machine learning is provided. The method receives a labeled data set. A set of data subsets is generated from the labeled data set. A set of unsupervised machine learning pipelines is generated. A training set is generated from the set of data subsets and the set of unsupervised machine learning pipelines. The method trains a metalearner for unsupervised tasks based on the training set.

According to an embodiment described herein, a system for a metalearner for automated machine learning is provided. The system includes one or more processors and a computer-readable storage medium, coupled to the one or more processors, storing program instructions that, when executed by the one or more processors, cause the one or more processors to perform operations. The operations receive a labeled data set. A set of data subsets is generated from the labeled data set. A set of unsupervised machine learning pipelines is generated. A training set is generated from the set of data subsets and the set of unsupervised machine learning pipelines. The operations train a metalearner for unsupervised tasks based on the training set.

According to an embodiment described herein, a computer program product for a metalearner for automated machine learning is provided. The computer program product includes a computer-readable storage medium having program instructions embodied therewith, the program instructions being executable by one or more processors to cause the one or more processors to receive a labeled data set. A set of data subsets is generated from the labeled data set. A set of unsupervised machine learning pipelines is generated. A training set is generated from the set of data subsets and the set of unsupervised machine learning pipelines. The computer program product trains a metalearner for unsupervised tasks based on the training set.

### BRIEF DESCRIPTION OF THE DRAWINGS

FIG. 1 depicts a block diagram of a computing environment for implementing concepts and computer-based methods, according to at least one embodiment.

FIG. 2 depicts a flow diagram of a computer-implemented method for a metalearner for automated machine learning, according to at least one embodiment.

FIG. 3 depicts a flow diagram of a computer-implemented method for a metalearner for automated machine learning, according to at least one embodiment.

FIG. 4 depicts a block diagram of a computing system for a metalearner for automated machine learning, according to at least one embodiment.

FIG. 5 is a schematic diagram of a cloud computing environment in which concepts of the present disclosure may be implemented, in accordance with an embodiment of the present disclosure.

FIG. 6 is a diagram of model layers of a cloud computing environment in which concepts of the present disclosure may be implemented, in accordance with an embodiment of the present disclosure.

### DETAILED DESCRIPTION

The present disclosure relates generally to methods for automated machine learning. More particularly, but not exclusively, embodiments of the present disclosure relate to a computer-implemented method for a metalearner for automated machine learning in unsupervised machine learning tasks. The present disclosure relates further to a related system for automated machine learning, and a computer program product for operating such a system.

Supervised machine learning uses labeled data sets to train machine learning algorithms. unsupervised machine learning uses unlabeled data sets to train machine learning algorithms. supervised machine learning algorithms and unsupervised machine learning algorithms are often tested by predict labels on unlabeled test data sets for which suitable labels are known but not provided to the machine learning algorithm under test.

Automated machine learning (AutoML) systems focus on supervised machine learning tasks and automate tasks of applying machine learning to real world problems. AutoML is often used to automate portions of machine learning algorithm generation and testing to enable use of machine learning by non-experts. Supervised AutoML methods do not extend to AutoML use in unsupervised machine learning tasks. Unsupervised AutoML is a problem that is fundamentally different than supervised AutoML.

Supervised AutoML systems often receive a labeled data set and splits the data set into training, cross-validation, and testing data subsets. The supervised AutoML system may then perform a pipeline search and hyperparameter optimization using the training and cross-validation data subsets. The supervised AutoML takes advantage of labels of the training and cross-validation data subsets to do this and performs join optimization operations at this point. The supervised AutoML system then tests a selected machine learning pipeline on the test data subset. Often, supervised AutoML systems iterate through a large search space. Due to the large search space used by supervised AutoML systems, these systems may be slow. As noted, these AutoML systems are limited in functionality to use in supervised machine learning.

AutoML for unsupervised machine learning would need to take unsupervised machine learning tasks as input, using unlabeled data sets. However, unlabeled data sets present difficulties for AutoML processes. While supervised AutoML employs joint optimization using a labels of a divided data set, AutoML in an unsupervised machine learning environment cannot take advantage of labels within an input data set. Due to the differences between supervised machine learning and unsupervised machine learning, present AutoML methods and systems are ill suited to use as unsupervised AutoML. Further, current AutoML systems do not support automatic pipeline generation and selection for unsupervised learning tasks, such as outlier detection and clustering.

Embodiments of the present disclosure provide a metalearning AutoML approach for unsupervised machine learning. Some embodiments of the present disclosure provide a metalearner for unsupervised AutoML capable of substantially reducing time to identifying optimal machine learning pipelines for unsupervised data sets over traditional unsupervised machine learning systems and methodology. Embodiments of the present disclosure provide an automated method to leverage supervised data sets to build a metalearner for unsupervised data sets. Embodiments of the present disclosure are scalable for new and developing unsupervised machine learning methods. Embodiments of the present disclosure may be applicable to a diverse set of unsupervised machine learning tasks. Embodiments of the present disclosure provide a metalearner system that is applicable to automatic machine learning pipeline generation and selection in unsupervised learning tasks. Some embodiments of the present disclosure provide a metalearner system that is applicable to outlier detection and clustering.

Some embodiments of the concepts described herein may take the form of a system or a computer program product. For example, a computer program product may store program instructions that, when executed by one or more processors of a computing system, cause the computing system to perform operations described above with respect to the computer-implemented method. By way of further example, the system may comprise components, such as processors and computer-readable storage media. The computer-readable storage media may interact with other components of the system to cause the system to execute program instructions comprising operations of the computer-implemented method, described herein. For the purpose of this description, a computer-usable or computer-readable medium may be any apparatus that may contain means for storing, communicating, propagating, or transporting the program for use, by, or in connection with, the instruction execution system, apparatus, or device.

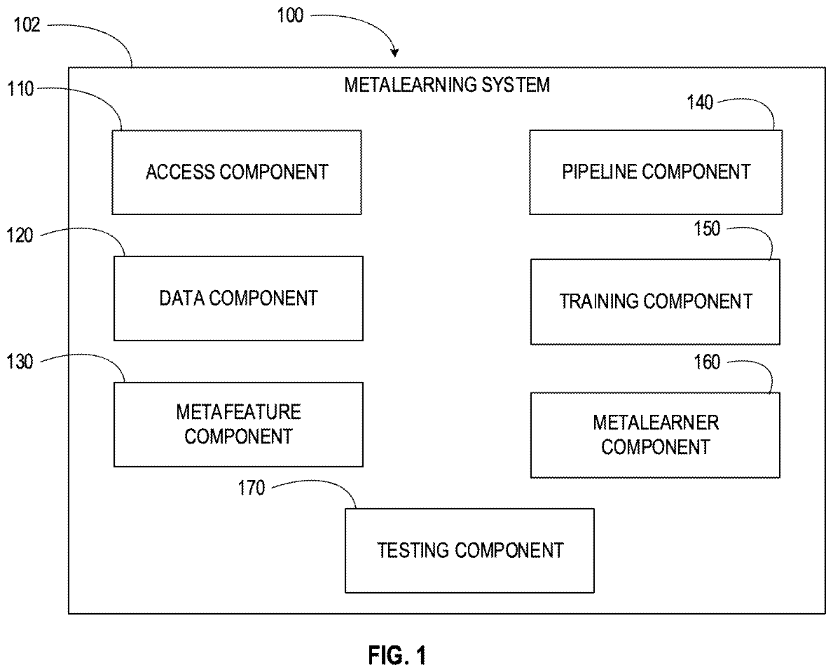

Referring now to FIG. 1, a block diagram of an example computing environment 100 is shown. The present disclosure may be implemented within the example computing environment 100. In some embodiments, the computing environment 100 may be included within or embodied by a computer system, described below. The computing environment 100 may include a metalearning system 102. The metalearning system 102 may comprise an access component 110, a data component 120, a metafeature component 130, a pipeline component 140, a training component 150, a metalearner component 160, and a testing component 170. The access component 110 receives data sets, including labeled data sets. The data component 120 generates sets of data subsets from received data sets. The metafeature component 130 generates sets of data metafeatures and sets of pipeline metafeatures. The pipeline component 140 generates sets of machine learning pipelines, including unsupervised machine learning pipelines. The training component 150 generates a training set for a metalearner from data subsets and machine learning pipelines. The metalearner component 160 trains a metalearner based on the training set. The testing component 170 applies trained metalearners on the data set metafeatures and the pipeline metafeatures in the training set and identifies, using the trained metalearner, optimal unsupervised machine learning pipelines. Although described with distinct components, it should be understood that, in at least some embodiments, components may be combined or divided, and/or additional components may be added without departing from the scope of the present disclosure.

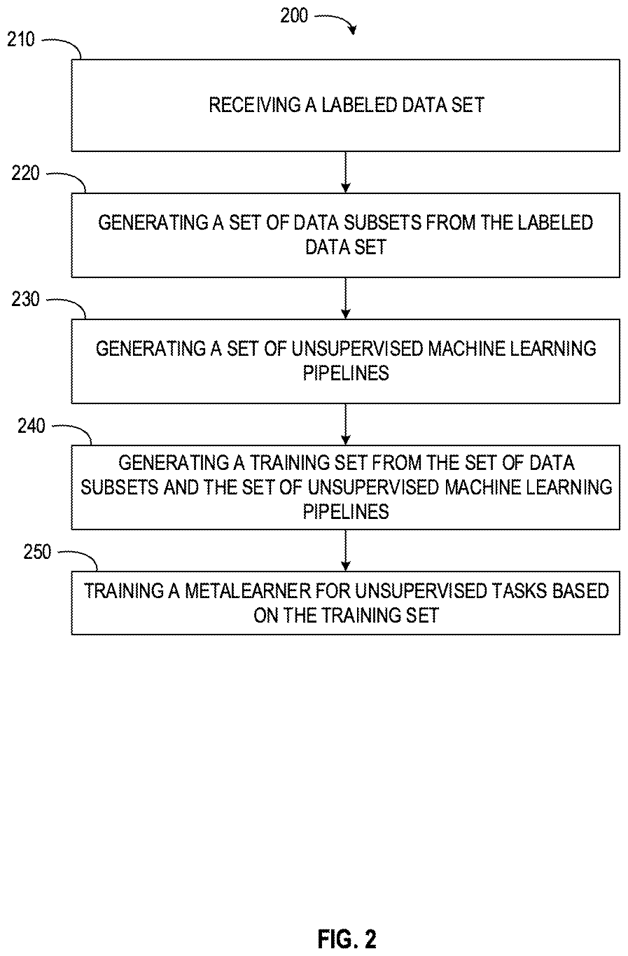

Referring now to FIG. 2, a flow diagram of a computer-implemented method 200 is shown. The computer-implemented method 200 is a method for training a metalearner for automated machine learning. In some embodiments, the computer-implemented method 200 may be performed by one or more components of the computing environment 100, as described in more detail below.

At operation 210, the access component 110 receives a labeled data set. The access component 110 may access the labeled data set as a labeled supervised data set. For example, the access component 110 may access the labeled data set from the University of California Irvine Machine Learning Repository, OpenML data sets, Kaggle® competition data sets, or any other suitable data set. The labeled data set may be a data set for classification tasks. In such instances, the labeled data set may include multiple class labels. In some embodiments, the access component 110 accesses the labeled data set in response to initiating creation of a metalearner within a user interface associated with the metalearning system 102.

At operation 220, the data component 120 generates a set of data subsets from the labeled data set. In some embodiments, the set of data subsets includes a plurality of data subsets. The set of data subsets may include a plurality of training data subsets, a plurality of cross-validation data subsets, and a plurality of test data subsets. In some instances, the set of data subsets are created to include a representative sample of each class label of the multiple class labels included in the labeled data set. In such instances, each data subset includes at data representing each class label of the multiple class labels within the labeled data set.

In some embodiments, while generating the set of data subsets, the data component 120 generates a labeled data subset from the labeled data set. For example, the labeled data subset may be a labeled data subset U. The labeled data subset U may be generated by selecting a random pair of class labels in the labeled data set. A number of rows in the labeled data subset U may be less than or equal to a number of rows within the labeled data set. For example, the labeled data subset U may include only two class labels. In some instances, the number of class labels included within the labeled data subset U is selected during generation of the set of data subsets. The number of class labels may be selected based on a number of available class labels within the labeled data set.

The data component 120 may also generate an outlier detection data subset from the labeled data set. The outlier detection data subset may be generated by downsampling rows of one class label within the labeled data set. In some embodiments, the outlier detection data subset is generated by downsampling rows and maintaining rows of other class labels unchanged. In such instances, the outlier detection data subset is generated as an unbalanced data subset. For example, the outlier detection data subset may be an outlier detection data subset O. The outlier detection data subset O may be an outlier data subset for the metalearner. In some instances, a plurality of outlier detection data subsets is generated from the labeled data set. Each outlier detection data subset may be generated with different class labels and different balances (i.e., different levels of imbalance between selected class labels) of included class labels. The outlier detection data subset may be generated to enable computation of performance metrics of unsupervised pipelines on the outlier detection data subset.

In some embodiments, the metafeature component 130 generates a set of data metafeatures for the set of data subsets. The metafeature component 130 generates data metafeatures for each set of data subsets. For example, the metafeature component 130 may generate data metafeatures for each labeled data subset and each outlier detection data subset. Each row of features within the set of data metafeatures may be a data set. The metafeature component 130 may generate the set of data metafeatures by cooperating with one or more components of the metalearning system 102 which may train and measure performance of unsupervised pipelines on data sets, such as the set of data subsets, data sets within the labeled data set, or the labeled data set. Based on the training and measured performance of the unsupervised pipelines, the metafeature component 130 computes the data set metafeatures for the set of data subsets.

At operation 230, the pipeline component 140 generates a set of unsupervised machine learning pipelines. The set of unsupervised machine learning pipelines do not require labels for training. The pipeline component 140 may generate the set of unsupervised machine learning pipelines by selecting a length of each pipeline. The length of each pipeline may be selected in terms of a number of blocks or stages for the pipeline. In some embodiments, the pipeline component 140 pre-selects a type of each block. The block types may be selected from types including imputation, scaling, feature engineering, final estimators, outlier detection, or any other suitable block type. Once the pipeline component 140 selects the block types to be included each unsupervised machine learning pipeline, the pipeline component 140 may select one or more options for each type. For example, the pipeline component 140 may select a block type of imputation for an unsupervised machine learning pipeline and select an option of k-nearest neighbor (kNN) imputation, simple imputation, or average imputation for the selected block type. By way of further example, the pipeline component 140 may select a block type of scaling for an unsupervised machine learning pipeline and select an option of standard scaler, abs scaler, minmax scaler, or any other suitable scaler option. The pipeline component 140 may also select options of Isolation Forest, AvgKNN, LocalOutlierFactor, or any other suitable options based on selected block types. The pipeline component 140 may sample a random pipeline of the set of unsupervised machine learning pipelines by sampling each block of a pipeline and parameters for each block type.

In some embodiments, the data component 120 generates an outlier detection data subset for each unsupervised machine learning pipeline of the set of unsupervised machine learning pipelines.

In some embodiments, the metafeature component 130 generates a set of pipeline metafeatures for the set of unsupervised machine learning pipelines. The metafeature component 130 may generate the set of pipeline metafeatures by computing the pipeline metafeatures based on measurement of performance of unsupervised pipelines on one or more of the labeled data set or the set of data subsets. Each row in the set of pipeline metafeatures may represent a pipeline of the set of unsupervised machine learning pipelines.

In some embodiments, the metafeature component 130 generates the set of pipeline metafeatures based on a selected scheme. The schemes may include one hot encoding pipelines, one hot encoding with pipeline components, and pipeline stage encoding. In one hot encoding pipelines, the metafeature component 130 has access to N unsupervised machine learning pipelines. The metafeature component 130 may use a binary vector of size N to generate the set of pipeline metafeatures. In such instances, the metafeature component 130 uses the binary vector of size N where a bit is set to one to indicate that the corresponding pipeline is used.

In one hot encoding with pipeline components, the metafeature component 130 has access to M pipeline components. The M pipeline components may include all transformers and estimators in all of the unsupervised machine learning pipelines. The metafeature component 130 may use a binary vector of size M. In such instances, the metafeature component 130 may use the binary vector of size M where a bit is set to one to indicate that the corresponding component (e.g., transformer/estimator) is used.

In pipeline stage encoding, the metafeature component 130 may access unsupervised machine learning pipelines with four steps. The steps of each pipeline may include imputation, scaling, feature engineering, and estimator. Within each pipeline step, the metafeature component 130 may use an identification of the component (e.g., transformer, estimator, etc.) in the encoding.

At operation 240, the training component 150 generates a training set. The training set may be generated for training a metalearner. The training set may be generated from the set of data subsets and the set of unsupervised learning pipelines. In some embodiments, the training set is generated from the set of data subsets, the data set metafeatures, and the pipeline metafeatures. In some instances, the training set includes a performance metric of pipelines on an unsupervised data set.

In some embodiments, the training set is generated by training an unsupervised machine learning pipeline. The unsupervised machine learning pipeline may be trained for each outlier detection data subset. In such instances, an unsupervised machine learning pipeline is paired with an outlier detection data subset. For each pair of outlier detection data subset O and unsupervised machine learning pipeline P, the training component 150 may train the unsupervised machine learning pipeline P on outlier detection data subset O. The training component 150 may train the unsupervised machine learning pipeline P without using class labels. The training component 150 may then evaluate performance of the pretrained unsupervised machine learning pipeline P on outlier detection data subset O. The training component 150 may evaluate the unsupervised machine learning pipeline P by identifying predictions (e.g., y_pred) for all rows of outlier detection data subset O produced by the trained unsupervised machine learning pipeline P. The training component 150 may use class labels (e.g., y_true) and predictions (e.g., y_pred) to compute a performance metric. The performance metric (e.g., receiver operating characteristic (ROC)) may be understood as ROC(y_true, y_pred).

Once the unsupervised machine learning pipeline for each outlier detection data subset is trained, the training component 150 combines data metafeatures of the set of data metafeatures, pipeline metafeatures of the set of pipeline metafeatures, and a pipeline performance metric to create a labeled training data set for the metalearner. Labels for the metalearner may be a pipeline performance metric.

Using the examples described above, the training component 150 generates the training set using the labeled data subset U, data set metafeatures associated with labeled data subset U, pipeline metafeatures, and pipeline performance metrics. The training component 150 may split the labeled data subset U into a labeled training set T and a labeled evaluation set E. The labeled training set T may be used for training the metalearner. The labeled evaluation set E may be used for evaluation of the metalearner.

At operation 250, the metalearner component 160 trains a metalearner for unsupervised tasks based on the training set. The metalearner component 160 may train the metalearner as a supervised metalearning model. The metalearner component 160 may train the metalearner using the dataset metafeatures, the pipeline metafeatures, and the training set. In some instances, the metalearner is trained using performance metrics of pipelines trained on an unsupervised data set. The metalearner is trained to predict performance given dataset metafeatures and pipeline metafeatures.

In some embodiments, the training component 150 trains the metalearner by separating the training set into a training data subset and an evaluation data subset. The metalearner component 160 trains the metalearner based on the training data subset (i.e., labeled training set T). The metalearner component 160 evaluates the metalearner based on the evaluation data subset (i.e., labeled evaluation set E). In some embodiments, the metalearner component 160 trains the metalearner as a regression method to predict performance of unsupervised machine learning pipelines on data sets in the labeled training set T. The training component 150 may evaluate the metalearner on labeled evaluation set E using a metric of normalized distributive cumulative gain (NDCG). In some embodiments, a diversity constraint is added while the training component 150 trains the metalearner. In such instances, the predicted pipelines identified by the metalearner will be diverse and not only a top-k of pipelines.

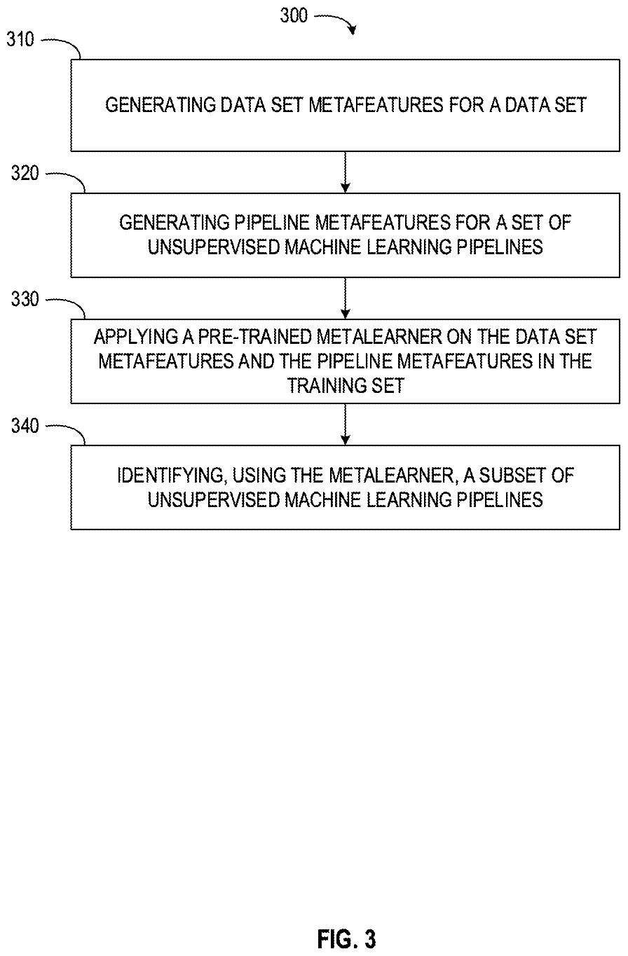

FIG. 3 shows a flow diagram of an embodiment of a computer-implemented method 300 for using a metalearner for automated machine learning. The method 300 may be performed by or within the computing environment 100. In some embodiments, the method 300 comprises or incorporates one or more operations of the method 200. In some instances, operations of the method 300 may be incorporated as part of or sub-operations of the method 200.

In operation 310, the metafeature component 130 generates data set metafeatures for a data set. In some embodiments, the data set is an unlabeled data set. The unlabeled data set may be a data set for unsupervised machine learning tasks. The data set metafeatures may be extracted from the data set upon accessing the data set during unsupervised AutoML operations using a trained metalearner. The unlabeled data set may be an unsupervised data set S. The metafeature component 130 may generate the data set metafeatures for the unsupervised data set S in a manner similar to or the same as described above.

In operation 320, the metafeature component 130 generates pipeline metafeatures for a set of unsupervised machine learning pipelines. In some embodiments, the metafeature component 30 generates the pipeline metafeatures by accessing and using pipeline metafeatures described above and generated for pipelines associated with labeled data subset U. In some embodiments, the pipeline metafeatures may be generated in a manner similar to or the same as described above.

In operation 330, the testing component 170 applies a pre-trained metalearner on the data set metafeatures and the pipeline metafeatures in the training set. In some embodiments, the data set metafeatures are appended to each pipeline metafeatures. Once the data set metafeatures are appended, the pretrained metalearner may be applied to the training set to predict performance of the set of unsupervised machine learning pipelines.

In operation 340, the testing component 170, identifies, using the metalearner, a subset of unsupervised machine learning pipelines. The subset of unsupervised machine learning pipelines may be a predicted subset of pipelines predicted as being among the top performing pipelines. In some embodiments, the subset of unsupervised machine learning pipelines are predicted by the metalearner as the top-k pipelines of the set of unsupervised machine learning pipelines. In some instances, the subset of unsupervised machine learning pipelines are machine learning pipelines that perform outlier detection for an unlabeled data set. The unlabeled data set may be a data set without class labels.

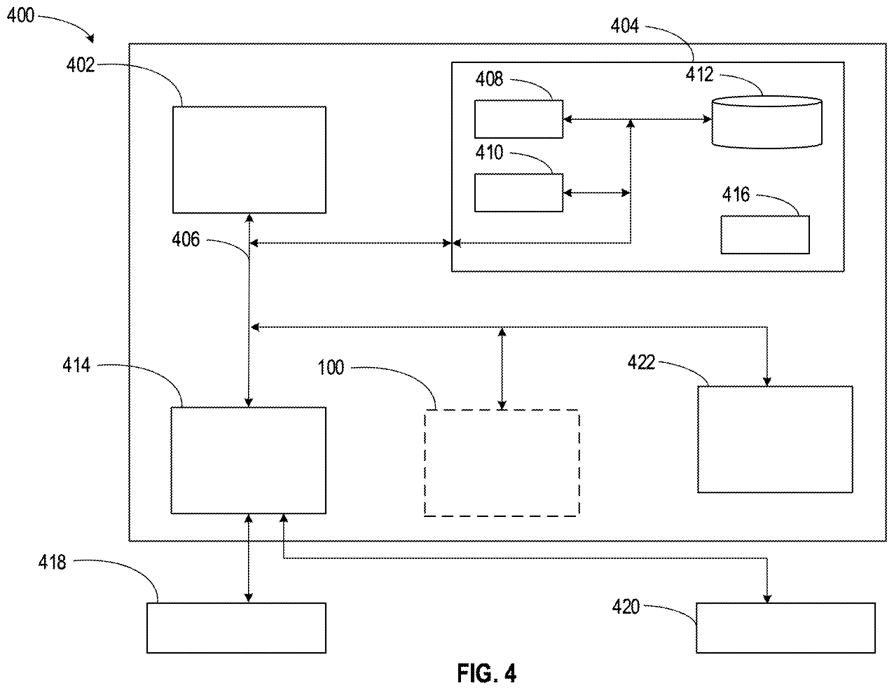

Embodiments of the present disclosure may be implemented together with virtually any type of computer, regardless of the platform is suitable for storing and/or executing program code. FIG. 4 shows, as an example, a computing system 400 (e.g., cloud computing system) suitable for executing program code related to the methods disclosed herein and for a metalearner for automated machine learning.

The computing system 400 is only one example of a suitable computer system and is not intended to suggest any limitation as to the scope of use or functionality of embodiments of the present disclosure described herein, regardless, whether the computer system 400 is capable of being implemented and/or performing any of the functionality set forth hereinabove. In the computer system 400, there are components, which are operational with numerous other general purpose or special purpose computing system environments or configurations. Examples of well-known computing systems, environments, and/or configurations that may be suitable for use with computer system/server 400 include, but are not limited to, personal computer systems, server computer systems, thin clients, thick clients, hand-held or laptop devices, multiprocessor systems, microprocessor-based systems, set-top boxes, programmable consumer electronics, network PCs, minicomputer systems, mainframe computer systems, and distributed cloud computing environments that include any of the above systems or devices, and the like. Computer system/server 400 may be described in the general context of computer system-executable instructions, such as program modules, being executed by a computer system 400. Generally, program modules may include routines, programs, objects, components, logic, data structures, and so on that perform particular tasks or implement particular abstract data types. Computer system/server 400 may be practiced in distributed cloud computing environments where tasks are performed by remote processing devices that are linked through a communications network. In a distributed cloud computing environment, program modules may be located in both, local and remote computer system storage media, including memory storage devices.

As shown in the figure, computer system/server 400 is shown in the form of a general-purpose computing device. The components of computer system/server 400 may include, but are not limited to, one or more processors 402 (e.g., processing units), a system memory 404 (e.g., a computer-readable storage medium coupled to the one or more processors), and a bus 406 that couple various system components including system memory 404 to the processor 402. Bus 406 represents one or more of any of several types of bus structures, including a memory bus or memory controller, a peripheral bus, an accelerated graphics port, and a processor or local bus using any of a variety of bus architectures. By way of example, and not limiting, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Computer system/server 400 typically includes a variety of computer system readable media. Such media may be any available media that is accessible by computer system/server 400, and it includes both, volatile and non-volatile media, removable and non-removable media.

The system memory 404 may include computer system readable media in the form of volatile memory, such as random-access memory (RAM) 408 and/or cache memory 410. Computer system/server 400 may further include other removable/non-removable, volatile/non-volatile computer system storage media. By way of example only, a storage system 412 may be provided for reading from and writing to a non-removable, non-volatile magnetic media (not shown and typically called a ‘hard drive’). Although not shown, a magnetic disk drive for reading from and writing to a removable, non-volatile magnetic disk (e.g., a ‘floppy disk’), and an optical disk drive for reading from or writing to a removable, non-volatile optical disk such as a CD-ROM, DVD-ROM or other optical media may be provided. In such instances, each can be connected to bus 406 by one or more data media interfaces. As will be further depicted and described below, the system memory 404 may include at least one program product having a set (e.g., at least one) of program modules that are configured to carry out the functions of embodiments of the present disclosure.

The program/utility, having a set (at least one) of program modules 416, may be stored in the system memory 404 by way of example, and not limiting, as well as an operating system, one or more application programs, other program modules, and program data. Program modules may include one or more of the access component 110, the data component 120, the metafeature component 130, the pipeline component 140, the training component 150, the metalearner component 160, and the testing component 170, which are illustrated in FIG. 1. Each of the operating systems, one or more application programs, other program modules, and program data or some combination thereof, may include an implementation of a networking environment. Program modules 416 generally carry out the functions and/or methodologies of embodiments of the present disclosure, as described herein.

The computer system/server 400 may also communicate with one or more external devices 418 such as a keyboard, a pointing device, a display 420, etc.; one or more devices that enable a user to interact with computer system/server 400; and/or any devices (e.g., network card, modem, etc.) that enable computer system/server 400 to communicate with one or more other computing devices. Such communication can occur via Input/Output (I/O) interfaces 414. Still yet, computer system/server 400 may communicate with one or more networks such as a local area network (LAN), a general wide area network (WAN), and/or a public network (e.g., the Internet) via network adapter 422. As depicted, network adapter 422 may communicate with the other components of computer system/server 400 via bus 406. It should be understood that, although not shown, other hardware and/or software components could be used in conjunction with computer system/server 400. Examples include, but are not limited to: microcode, device drivers, redundant processing units, external disk drive arrays, RAID systems, tape drives, and data archival storage systems, etc.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Service models may include software as a service (SaaS), platform as a service (PaaS), and infrastructure as a service (IaaS). In SaaS, the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings. In PaaS, the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations. In IaaS, the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment models may include private cloud, community cloud, public cloud, and hybrid cloud. In private cloud, the cloud infrastructure is operated solely for an organization. It may be managed by the organization or a third party and may exist on-premises or off-premises. In community cloud, the cloud infrastructure is shared by several organizations and supports specific community that has shared concerns (e.g., mission, security requirements, policy, and compliance considerations). It may be managed by the organizations or a third party that may exist on-premises or off-premises. In public cloud, the cloud infrastructure is made available to the general public or a large industry group and is owned by an organization selling cloud services. In hybrid cloud, the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling modularity, and semantic interoperability. At the heart of cloud computing is an infrastructure that includes a network of interconnected nodes.

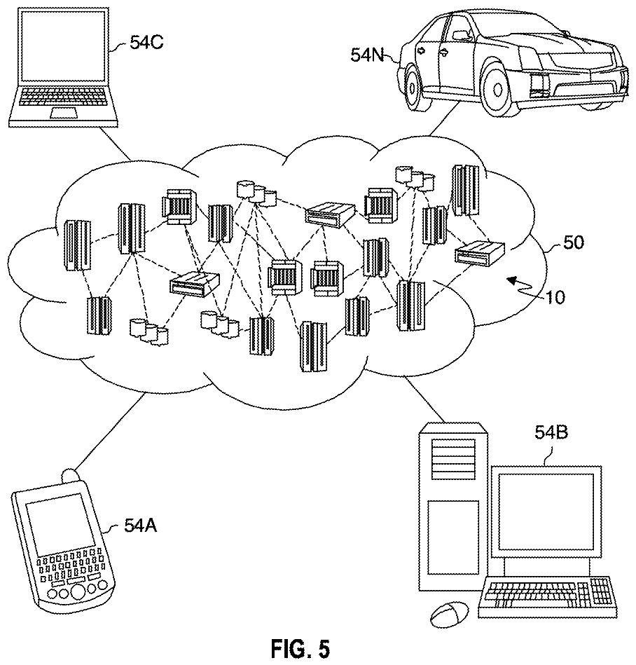

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

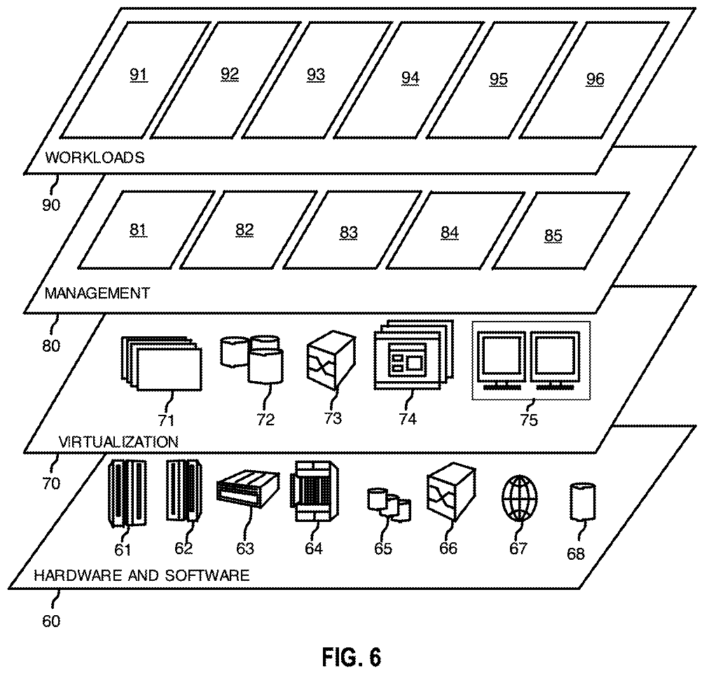

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the disclosure are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and metalearner processing 96.

Cloud models may include characteristics including on-demand self-service, broad network access, resource pooling, rapid elasticity, and measured service. In on-demand self-service a cloud consumer may unilaterally provision computing capabilities such as server time and network storage, as needed automatically without requiring human interaction with the service's provider. In broad network access, capabilities are available over a network and accessed through standard mechanisms that promote use by heterogeneous thin or thick client platforms (e.g., mobile phones, laptops, and PDAs). In resource pooling, the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter). In rapid elasticity, capabilities can be rapidly and elastically provisioned, in some cases automatically, to quickly scale out and rapidly released to quickly scale in. To the consumer, the capabilities available for provisioning often appear to be unlimited and can be purchased in any quantity at any time. In measured service, cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

The descriptions of the various embodiments of the present disclosure have been presented for purposes of illustration, but are not intended to be exhaustive or limited to the embodiments disclosed. Many modifications and variations will be apparent to those of ordinary skills in the art without departing from the scope and spirit of the described embodiments. The terminology used herein was chosen to best explain the principles of the embodiments, the practical application or technical improvement over technologies found in the marketplace, or to enable others of ordinary skills in the art to understand the embodiments disclosed herein.

The present invention may be embodied as a system, a method, and/or a computer program product. The computer program product may include a computer-readable storage medium (or media) having computer readable program instructions thereon for causing a processor to carry out aspects of the present invention.

The computer-readable storage medium may be an electronic, magnetic, optical, electromagnetic, infrared or a semi-conductor system for a propagation medium. Examples of a computer-readable medium may include a semi-conductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W), DVD and Blu-Ray-Disk.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disk read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer-readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Smalltalk, C++ or the like, and conventional procedural programming languages, such as the “C” programming language or similar programming languages. The computer readable program instructions may execute entirely on the user's computer, partly on the user's computer as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatuses, or another device to cause a series of operational steps to be performed on the computer, other programmable apparatus or other device to produce a computer implemented process, such that the instructions which execute on the computer, other programmable apparatuses, or another device implement the functions/acts specified in the flowchart and/or block diagram block or blocks.

The flowcharts and/or block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or act or carry out combinations of special purpose hardware and computer instructions.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will further be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims below are intended to include any structure, material, or act for performing the function in combination with other claimed elements, as specifically claimed. The description of the present disclosure has been presented for purposes of illustration and description, but is not intended to be exhaustive or limited to the present disclosure in the form disclosed. Many modifications and variations will be apparent to those of ordinary skills in the art without departing from the scope of the present disclosure. The embodiments are chosen and described in order to explain the principles of the present disclosure and the practical application, and to enable others of ordinary skills in the art to understand the present disclosure for various embodiments with various modifications, as are suited to the particular use contemplated.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving a labeled data set;
generating a set of data subsets from the labeled data set;
generating a set of unsupervised machine learning pipelines;
generating a training set from the set of data subsets and the set of unsupervised machine learning pipelines; and
training a metalearner for unsupervised tasks based on the training set.

2. The method of claim 1, further comprising:
generating a set of data metafeatures for the set of data subsets; and
generating a set of pipeline metafeatures for the set of unsupervised machine learning pipelines.

3. The method of claim 2, wherein generating the set of data subsets further comprises:
generating a labeled data subset from the labeled data set; and
generating an outlier detection data subset from the labeled data set.

4. The method of claim 3, wherein an outlier detection data subset is generated for each unsupervised machine learning pipeline.

5. The method of claim 4, wherein generating the training set further comprises:
training an unsupervised machine learning pipeline for each pair of outlier detection data subset; and
combining data metafeatures of the set of data metafeatures, pipeline metafeatures of the set of pipeline metafeatures, and a pipeline performance metric to create a labeled training data set for the metalearner.

6. The method of claim 5, wherein training the metalearner further comprises:
separating the training set into a training data subset and an evaluation data subset;
training the metalearner based on the training data subset; and
evaluating the metalearner based on the evaluation data subset.

7. The method of claim 1, further comprising:
generating data set metafeatures for the labeled data set;
generating pipeline metafeatures for the set of unsupervised machine learning pipelines;
applying the metalearner on the data set metafeatures and the pipeline metafeatures in the training set; and
identifying, using the metalearner, a subset of unsupervised machine learning pipelines.

8. A system, comprising:
one or more processors; and
a computer-readable storage medium, coupled to the one or more processors, storing program instructions that, when executed by the one or more processors, cause the one or more processors to perform operations comprising:
receiving a labeled data set;
generating a set of data subsets from the labeled data set;
generating a set of unsupervised machine learning pipelines;
generating a training set from the set of data subsets and the set of unsupervised machine learning pipelines; and
training a metalearner for unsupervised tasks based on the training set.

9. The system of claim 8, wherein the operations further comprise:
generating a set of data metafeatures for the set of data subsets; and
generating a set of pipeline metafeatures for the set of unsupervised machine learning pipelines.

10. The system of claim 9, wherein generating the set of data subsets further comprises:
generating a labeled data subset from the labeled data set; and
generating an outlier detection data subset from the labeled data set.

11. The system of claim 10, wherein an outlier detection data subset is generated for each unsupervised machine learning pipeline.

12. The system of claim 11, wherein generating the training set further comprises:
training an unsupervised machine learning pipeline for each pair of outlier detection data subset; and
combining data metafeatures of the set of data metafeatures, pipeline metafeatures of the set of pipeline metafeatures, and a pipeline performance metric to create a labeled training data set for the metalearner.

13. The system of claim 12, wherein training the metalearner further comprises:
separating the training set into a training data subset and an evaluation data subset;
training the metalearner based on the training data subset; and
evaluating the metalearner based on the evaluation data subset.

14. The system of claim 8, wherein the operations further comprise:
generating data set metafeatures for the labeled data set;
generating pipeline metafeatures for the set of unsupervised machine learning pipelines;
applying the metalearner on the data set metafeatures and the pipeline metafeatures in the training set; and
identifying, using the metalearner, a subset of unsupervised machine learning pipelines.

15. A computer program product comprising a computer readable storage medium having program instructions embodied therewith, the program instructions being executable by one or more processors to cause the one or more processors to perform operations comprising:
receiving a labeled data set;
generating a set of data subsets from the labeled data set;
generating a set of unsupervised machine learning pipelines;
generating a training set from the set of data subsets and the set of unsupervised machine learning pipelines; and
training a metalearner for unsupervised tasks based on the training set.

16. The computer program product of claim 15, wherein the operations further comprise:
generating a set of data metafeatures for the set of data subsets; and
generating a set of pipeline metafeatures for the set of unsupervised machine learning pipelines.

17. The computer program product of claim 16, wherein generating the set of data subsets further comprises:
generating a labeled data subset from the labeled data set; and
generating an outlier detection data subset from the labeled data set for each unsupervised machine learning pipeline.

18. The computer program product of claim 17, wherein generating the training set further comprises:
training an unsupervised machine learning pipeline for each pair of outlier detection data subset; and
combining data metafeatures of the set of data metafeatures, pipeline metafeatures of the set of pipeline metafeatures, and a pipeline performance metric to create a labeled training data set for the metalearner.

19. The computer program product of claim 18, wherein training the metalearner further comprises:
separating the training set into a training data subset and an evaluation data subset;
training the metalearner based on the training data subset; and
evaluating the metalearner based on the evaluation data subset.

20. The computer program product of claim 15, wherein the operations further comprise:
generating data set metafeatures for the labeled data set;
generating pipeline metafeatures for the set of unsupervised machine learning pipelines;
applying the metalearner on the data set metafeatures and the pipeline metafeatures in the training set; and
identifying, using the metalearner, a subset of unsupervised machine learning pipelines.
